(19) United States
(12) Patent Application Publication
(10) Pub. No.: US 2024/0207678 A1
(43) Pub. Date: Jun. 27, 2024

(54) AUXILIARY SYSTEM AND METHOD FOR MOTION GUIDANCE

(71) Applicant: INDUSTRIAL TECHNOLOGY RESEARCH INSTITUTE, Hsinchu (TW)

(72) Inventors: Chun-Hung LIEN, Taipei City (TW); Chan-Hsuan YANG, Yuanlin City (TW); Yu-Yang LIN, Taoyuan City (TW); Bo-Yu HOU, Tainan City (TW)

(73) Assignee: INDUSTRIAL TECHNOLOGY RESEARCH INSTITUTE, Hsinchu (TW)

(21) Appl. No.: 18/089,231

(22) Filed: Dec. 27, 2022

(51) Int. Cl. A63B 24/00; G06T 7/20; G06V 10/764; G06V 20/40

(52) U.S. Cl. CPC A63B 24/0006; G06T 7/20; G06V 10/764; G06V 20/46; A63B 2024/0012; G06T 2207/20044; G06T 2207/20081; G06T 2207/30196

(57) ABSTRACT

An auxiliary method for motion guidance performs the following steps by a server: obtaining a video recording a human body performing a motion, analyzing the video to generate a plurality of skeleton coordinate sequences corresponding to the human body by a skeleton analysis module, specifying a key frame by a key frame analysis model at least according to the video and the plurality of skeleton coordinate sequences, generating an auxiliary image by a pose correction analysis model according to the key frame, a key skeleton coordinate corresponding to the key frame, and a skeleton coordinate template, and sending the video and a recommended guidance to an electronic device by the server, where the recommended guidance includes a composition result of the key frame and the auxiliary image.

### BACKGROUND

### 1. Technical Field

The present disclosure relates to motion posture analysis and machine learning, in particular to an auxiliary method for motion guidance.

### 2. Related Art

Golf is an outdoor sport that can maintain social distance. During the epidemic, consumers suddenly have a lot of free time and money. As a result, more and more people join the sport of golf, including beginners trying it for the first time.

However, golf is a sport that requires high precision. Whether beginners build basic knowledge or advanced players adjust their swing postures, they all rely on coach guidance. While novice players have plenty of time and disposable income to take lessons and practice, the biggest problem is finding the right and available coach to teach them. Limited by geographical factors, it is difficult for a single coach to travel to different regions to guide local students in a short period of time. In addition, the coach often needs to spend a lot of time correcting the student's body postures during the class, and thus delaying the teaching progress. Although there are some applications (apps) installed on smartphones that allow students to self-detect their swing posture, this method is still not as good as the coach's personal guidance.

### SUMMARY

In view of the above, the present disclosure proposes an auxiliary method for motion guidance, which makes the coach can handle the guidance requests from a plurality of students in different locations at the same time, and can improve the coach's guidance efficiency.

According to an embodiment of the present disclosure, an auxiliary method for motion guidance includes the following steps: obtaining a video recording a human body performing a motion; analyzing, by a skeleton analysis module, the video to generate a plurality of skeleton coordinate sequences corresponding to the human body; specifying, by a key frame analysis model, a key frame at least according to the video and the plurality of skeleton coordinate sequences; generating, by a pose correction model, an auxiliary image according to the key frame, a key skeleton coordinate corresponding to the key frame, and a skeleton coordinate template; and sending, by the server, the video and a recommended guidance to an electronic device, wherein the recommended guidance comprises a composite result of the key frame and auxiliary image.

According to an embodiment of the present disclosure, an auxiliary system for motion guidance includes a server and an electronic device. The server includes a communication circuit, a computing circuit, and a storage circuit. The communication circuit is configured to receive a video, send the video and send a recommended guidance, where the video records a human body performing a motion. The computing circuit is electrically connected to the communication circuit. The computing circuit is configured to perform a skeleton analysis module to analyze the video to generate a plurality of skeleton coordinate sequences corresponding to the human body; perform a key frame analysis model to specify a key frame at least according to the video and the plurality of skeleton coordinate sequences; and perform a pose correction model to generate an auxiliary image according to the key frame, a key skeleton coordinate corresponding to the key frame, and a skeleton coordinate template. The storage circuit is electrically connected to the computing circuit. The storage circuit is configured to store the skeleton analysis module, the plurality of skeleton coordinate sequences, the key frame analysis model, an index of the key frame, the pose correction model, and the auxiliary image. The electronic device is communicably connected to the server. The electronic device is configured to receive the video and the recommended guidance, and the recommended guidance comprises a composite result of the key frame and the auxiliary image.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1 is an application scenario diagram of the auxiliary system for motion guidance according to an embodiment of the present disclosure;

FIG. 2 is a block diagram of the auxiliary system for motion guidance according to an embodiment of the present disclosure;

FIG. 3 is a schematic diagram of the operation of the student recording and sending the video;

FIG. 4 is a block diagram of a storage circuit according to an embodiment of the present disclosure;

FIG. 5 is a flowchart of the auxiliary method for motion guidance according to an embodiment of the present disclosure;

FIG. 6 is a schematic diagram according to a human body skeleton;

FIG. 7 is a flowchart of the first implementation of the key frame analysis model;

FIG. 8 is a flowchart of the second implementation of the key frame analysis model;

FIG. 9 is a flowchart of performing the first collection procedure once;

FIG. 10 is a flowchart of performing the second collection procedure once;

FIG. 11 is a schematic diagram of the annotated image; and

FIG. 12 is a flowchart of performing the third collection procedure once.

### DETAILED DESCRIPTION

In the following detailed description, for purposes of explanation, numerous specific details are set forth in order to provide a thorough understanding of the disclosed embodiments. According to the description, claims and the drawings disclosed in the specification, one skilled in the art may easily understand the concepts and features of the present invention. The following embodiments further illustrate various aspects of the present invention, but are not meant to limit the scope of the present invention.

The present disclosure proposes an auxiliary system for motion guidance and method thereof. The following paragraphs adopts golf as an example to explain the proposed system and method. However, the sport applicable of the present disclosure is not limited thereto.

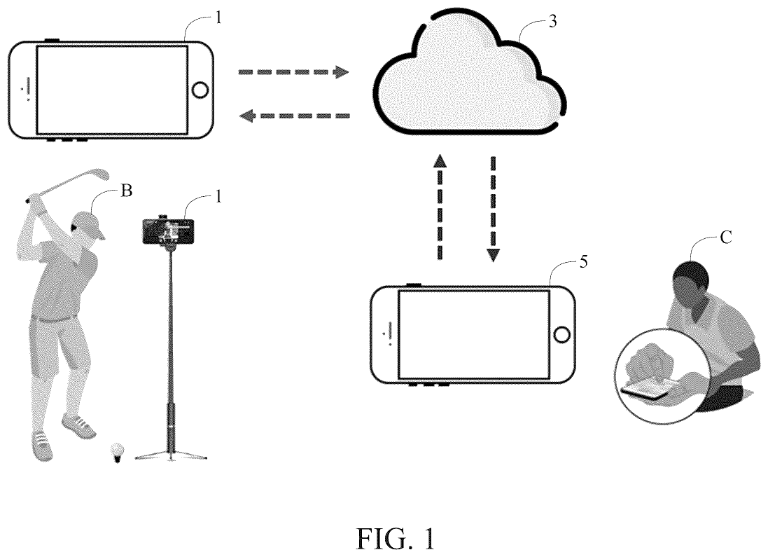

FIG. 1 is an application scenario diagram of the auxiliary system for motion guidance according to an embodiment of the present disclosure. As shown in FIG. 1, a student B uses an electronic device 1 or a smartphone to capture a video of him playing golf, and the video records a human body performing the motions. The electronic device 1 sends the video to the server 3. The server 3 analyzes the movement posture of the human body in the video, generates a recommended guidance, and then sends the video and recommended guidance to the electronic device 5 held by a coach C. The coach generates a formal guidance by fine-tuning the recommended guidance, or generates the formal guidance just based on the video, and then sends the video and the formal guidance to the electronic device 1 of the student B through the server 3.

The electronic device 1 and electronic device 5 held by the student B and coach C respectively may be a smart phone, a tablet computer or a personal computer with a camera. The present disclosure does not limit the hardware types of electronic devices 1 and 5.

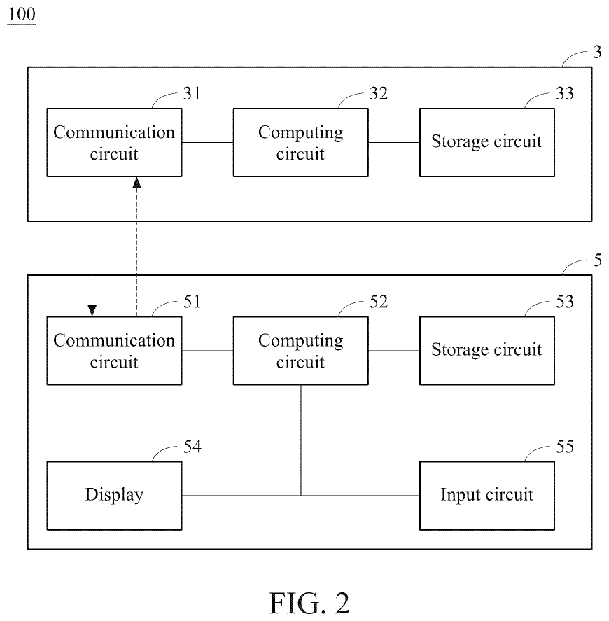

The auxiliary system 100 for motion guidance according to an embodiment of the present disclosure includes a server 3 that may automatically generate the recommended guidance based on video and an electronic device 5 that coach C uses to generate the formal guidance. FIG. 2 is a block diagram of the auxiliary system for motion guidance according to an embodiment of the present disclosure. As shown in FIG. 2, the server 3 includes a communication circuit 31, a computing circuit 32 and a storage circuit 33. The electronic device 5 includes a communication circuit 51, a computing circuit 52, a storage circuit 53, a display 54 and an input circuit 55.

The communication circuit 31 is configured to receive the video from the electronic device 1 of the student B, send the video and the recommended guidance to electronic device 5 of coach C, and send the formal guidance to the electronic device 1 of the student B. In an embodiment, the communication circuit 31 is, for example, a network card or a network chip, and the communication circuit 31 may use wired communication or wireless communication. The present disclosure does not limit the hardware type and communication mode of the communication circuit 31.

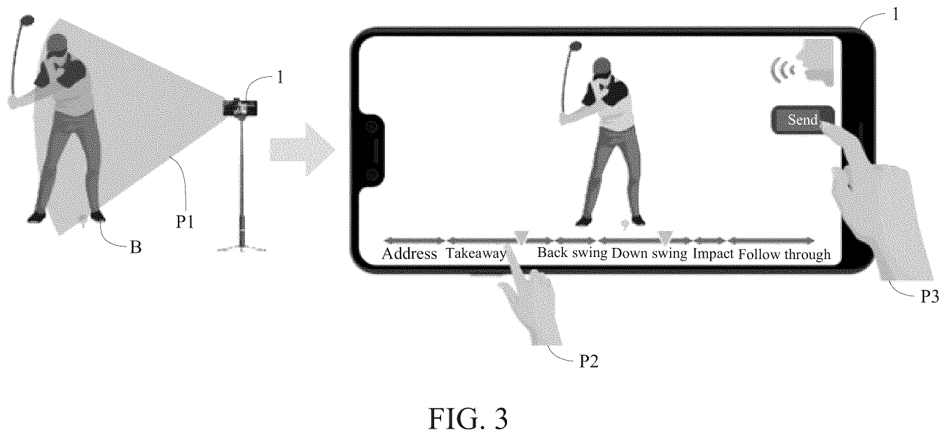

Please refer to FIG. 2 and FIG. 3. FIG. 3 is a schematic diagram of the operation of the student B recording and sending the video. In an embodiment, in addition to the video, the communication circuit 31 further receives stage partition information 82. As shown in FIG. 3, in the operation P1, the student B uses the camera function of the electronic device 1 to capture a video of motions. In the operation P2, the application running on the electronic device 1, for example, adopts the “Golf swing motion analysis method” proposed in the Republic of China Patent Publication No. TWI775243B to divide the video into a plurality of intervals, and each interval corresponds to a stage of golf. As shown in FIG. 3, playing golf may be divided into six stages: address, takeaway, back swing, down swing, impact, and follow through. The stage partition information 82 is, for example, the start time point and end time point of each stage. In operation P2, student B may decide the part that requires coach's guidance by setting a certain stage or a certain time point. The student B may also attach a voice message so that coach C can understand the problem. In the operation P3, the electronic device 1 sends the video including the voice message and the stage partition information 82 to the server 3.

As shown in FIG. 2, the computing circuit 32 is electrically connected to the communication circuit 32. The computing circuit 32 may execute a module or a model to analyze motions in video. In an embodiment, the module or model includes: a skeleton analysis module, which analyzes the video to generate a plurality of skeleton coordinate sequences corresponding to the human body; a key frame analysis model, which specifies a key frame at least according to the video and the plurality of skeleton coordinate sequences; a pose correction model, which generates an auxiliary image according to the key frame, a key skeleton coordinate corresponding to the key frame and a skeleton coordinate template.

In another embodiment, the module or model further includes a speech meaning analysis model, which generates an auxiliary text according to the key frame, the key skeleton coordinate corresponding to the key frame, and the skeleton coordinate template. In further another embodiment, the module or model further includes a training module, which adjusts hyper-parameters of the key frame analysis model and/or pose correction model according to the formal guidance.

In an embodiment, the computing circuit 32 may be implemented by one or more of the following examples: a central processor unit (CPU), a microcontroller (MCU), an application processor (AP), a field programmable gate array(FPGA), an Application Specific Integrated Circuit (ASIC), a Digital Signal Processor (DSP), a system-on-a-chip (SOC), a deep learning accelerator, or any electronic device used to execute the described models and modules.

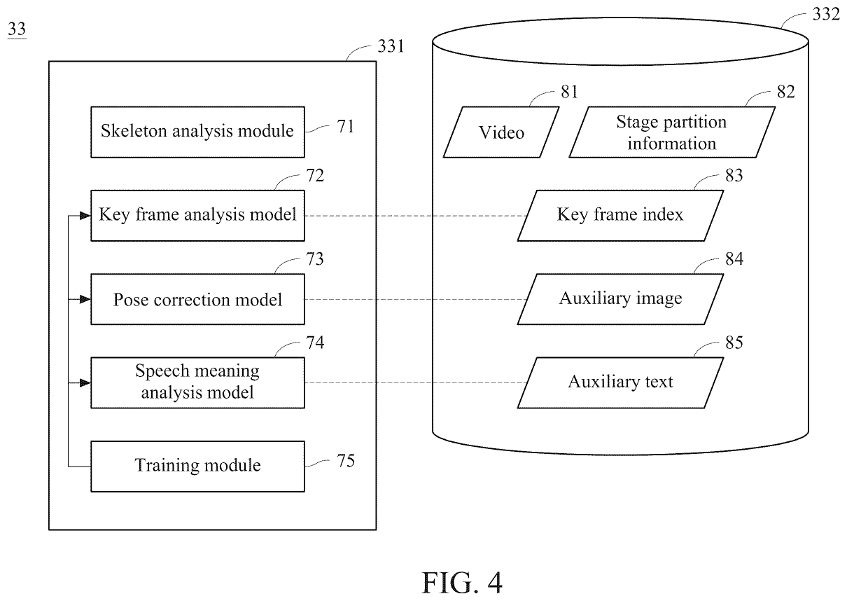

Please refer to FIG. 2 and FIG. 4. FIG. 4 is a block diagram of a storage circuit 33 according to an embodiment of the present disclosure. The storage circuit 33 is electrically connected to the computing circuit 34. The storage circuit 33 includes a program block 331 and a data block 332. The program block 331 stores the modules or models executed by the computing circuit 34. The modules or models include the skeleton analysis module 71, the key frame analysis model 72, the pose correction model 73, the speech meaning analysis model 74 and the training module 75. The data block 332 stores the output data of the modules 71, 75 or models 72, 73, 74. The output data include the video 81, the stage partition information 82, a key frame index 83, the auxiliary image 84 and the auxiliary text 85.

The electronic device 5 is communicably connected with the server 3 through the communication circuit 52. The communication circuit 52 is configured to receive the video 81 and the recommended guidance, and send the formal guidance. In an embodiment, the recommended guidance includes a composite result of the key frame and the auxiliary image 84. In another embodiment, the recommended guidance further includes the auxiliary text 85 displayed in the key frame.

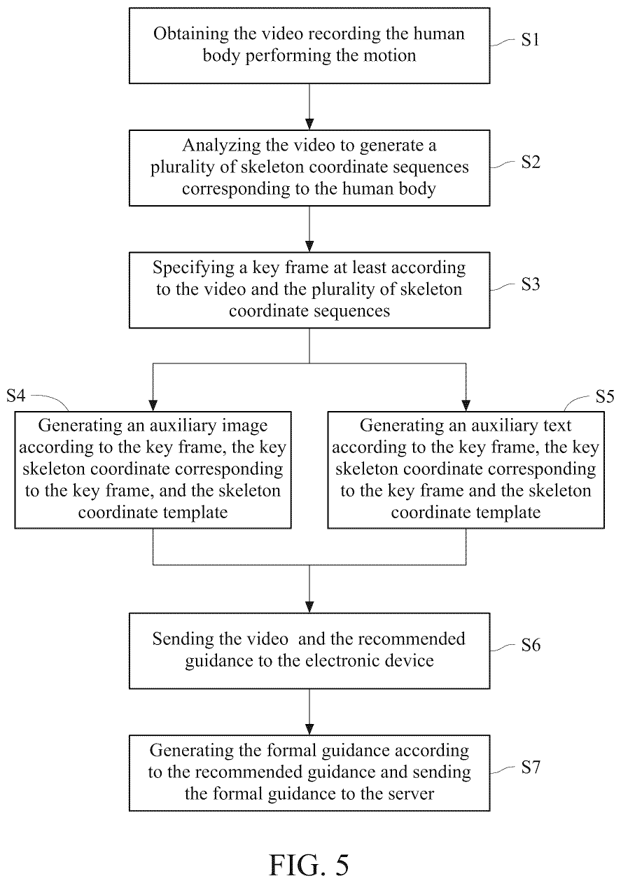

FIG. 5 is a flowchart of the auxiliary method for motion guidance according to an embodiment of the present disclosure and includes steps S1 to S7. In other embodiments, step 5 and/or step 7 may be omitted.

In step S1, the communication circuit 32 obtains the video 81 recording the human body performing the motion from the electronic device 1. In an embodiment, in addition to receiving the video 81, the communication circuit 32 also receives the stage partition information 82 from the electronic device 1.

In step S2 to step S5, the computing circuit 31 of the server 3 reads from the storage circuit 36 and executes the model or module mentioned in the steps.

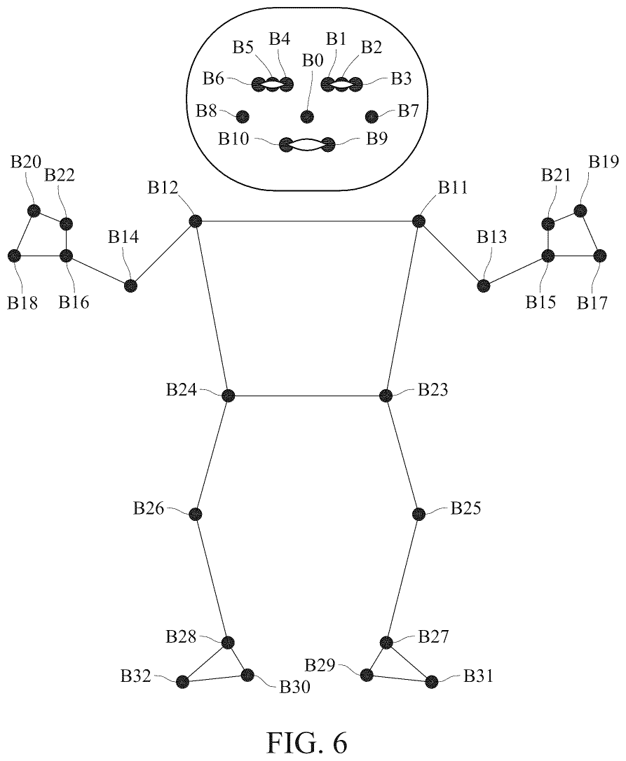

In step S2, the skeleton analysis module 71 analyzes the video 81 to generate a plurality of skeleton coordinate sequences corresponding to the human body. In an embodiment, in order to reduce the overhead of the server 3, the skeleton analysis module 71 may be implemented through the functions provided by the skeleton analysis software development kit (SDK) of the mobile device platform, for example, the ARkit on the iOS platform, or the MediaPipe Pose framework released by Google. The video 81 includes a plurality of frames, and each frame has a skeleton coordinate sequence. FIG. 6 is a schematic diagram according to a human body skeleton. As shown in FIG. 6, the human body skeleton includes feature points of multiple human body parts such as B0 to B31. In an embodiment, the skeleton coordinate sequence consists of the three-dimensional coordinates of these feature points, for example: [B0(x₀, y₀, z₀), B1(x₁, y₁, z₁), . . . , B31(x₃₁, y₃₁, z₃₁)]. In an embodiment, the skeleton coordinate sequences generated by the skeleton analysis module 71 may be stored in the data block 332 of the storage circuit 33, and this may accelerate the subsequent service or re-training of the model.

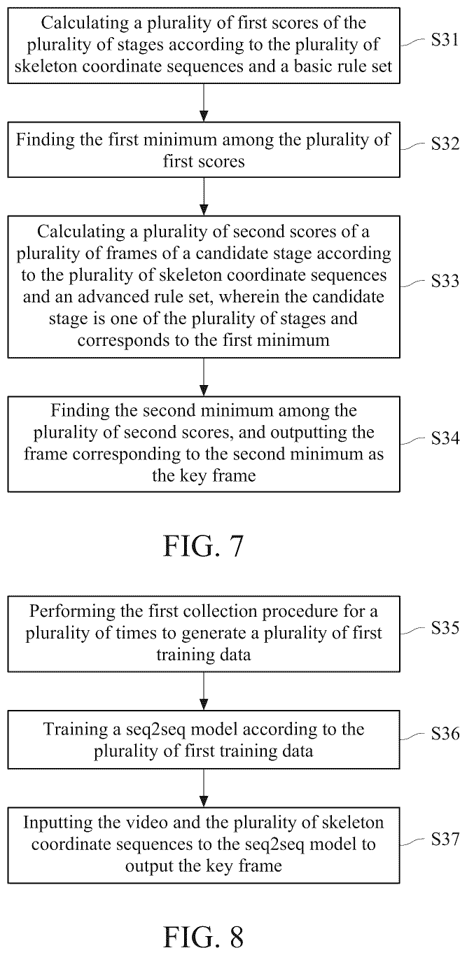

In step S3, the key frame analysis model 72 specifies a key frame at least according to the video 81 and the plurality of skeleton coordinate sequences. The key frame analysis model 72 is configured to find out the motion poses in the video 81 that need to be corrected. Based on the amount of collected data, the key frame analysis model 72 adopts the following two implementations. Please refer to FIG. 7 and FIG. 8. FIG. 7 is a flowchart of the first implementation of the key frame analysis model 72. FIG. 8 is a flowchart of the second implementation of the key frame analysis model 72.

The first implementation: in the early stage of the operation of the auxiliary system 100 for motion guidance, the server 3 has not yet collected a sufficient number of guidance cases (including the video 81, the recommended guidance and the formal guidance). Therefore, the key frame analysis model 72 scores each stage of the motion according to the rule set defined in advance, and finds the stage and time point with the lowest score. The rule set includes a plurality of rules. In an embodiment, each stage of the motion has multiple rules obtained from expert interviews, such as: hands should be straight, hands and shoulders should form an inverted triangle, center of gravity should be on the left of the middle, . . . , etc. The score is determined by the similarity between the student's posture and the rule. The more similar the posture is to the rules, the higher the score. The more the posture deviates from the rules, the lower the score.

As shown in FIG. 7, in step 531, the key frame analysis model 72 calculates a plurality of first scores of the plurality of stages according to the plurality of skeleton coordinate sequences and a basic rule set. Each stage of the motion has one score. In step 532, the key frame analysis model 72 finds the first minimum among the plurality of first scores. In other words, the key frame analysis model 72 determines how well a student's posture conforms to the rules of the basic rule set, and then scores each stage of motion and then finds the stage with the lowest score. The basic rule set includes a few rules with high priority among the plurality of rules. In an embodiment, among the plurality of rules applicable to each stage, the key frame analysis model 72 only adopts a few rules with high priority, so the speed of judgment can be accelerated.

As shown in FIG. 7, in step S33, the key frame analysis model 72 calculates a plurality of second scores of a plurality of frames of a candidate stage according to the plurality of skeleton coordinate sequences and an advanced rule set, where the candidate stage is one of the plurality of stages and corresponds to the first minimum. In an embodiment, the advanced rule set is a superset of the basic rule set. That is, the advanced rule set includes more rules than the basic rule set. The key frame analysis model 72 uses a few rules in the basic rule set to quickly find the candidate stage and uses more rules in the advanced rule set to finely score every frame of a specified stage of the motion. In step 534, the key frame analysis model 72 finds the second minimum among the plurality of second scores, and the frame corresponding to the second minimum is output as the key frame. Specifically, each frame of the candidate stage has a second score determined according to the rules in the advanced rule set, and the key frame analysis model 72 outputs the frame with the lowest second score as the key frame. Overall, after finding the stage with the lowest score, the key frame analysis model 72 uses the advanced rule set to obtain the score of each frame of the candidate stage, and then find the frame with the lowest score among the plurality of frames in as the key frame.

The second implementation: after the auxiliary system 100 for motion guidance has been running for a period of time, the server 3 has collected a sufficient number of guidance cases. Therefore, the server 3 may find out the relationship between the historical skeleton information and the time points according to the historical guidance, and further find out the time point with the highest probability of being selected from the video 81.

As shown in FIG. 8, in step S35, the computing circuit 32 of server 3 performs the first collection procedure for a plurality of times to generate a plurality of first training data. In step S36, the computing circuit 32 trains a sequence-to-sequence (seq2seq) model as the key frame analysis model 72 according to the plurality of first training data. In step S37, the computing circuit 32 inputs the video 81 and the plurality of skeleton coordinate sequences to the seq2seq model to output the key frame.

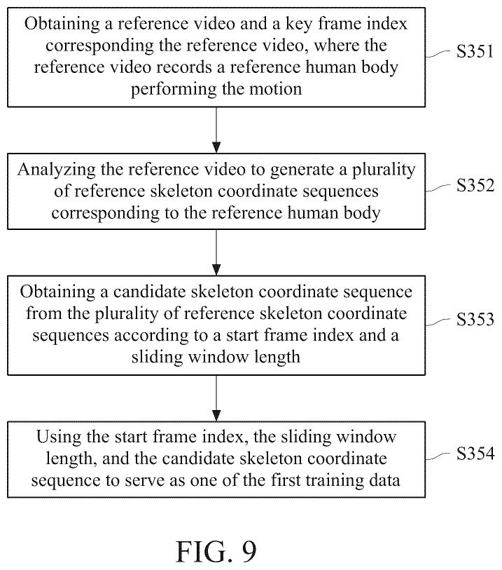

A piece of the first training data is generated every time the first collection procedure is performed. FIG. 9 is a flowchart of performing the first collection procedure once. As shown in FIG. 9, each of the plurality of times of the first collection procedure includes steps S351 to S354.

In step S351, the computing circuit 32 of the server 3 obtains a reference video and a key frame index 83 corresponding the reference video, where the reference video records a reference human body performing the motion. Specifically, after the auxiliary system 100 for motion guidance has been running for a period of time, the server 3 has collected the videos 81 (reference video) uploaded by different student B (reference human body), as well as the key frame specifically picked out by the coach C in each reference video. The key frame is the frame where the student B made a wrong posture during the motion.

In step S352, the skeleton analysis module 71 analyzes the reference video to generate a plurality of reference skeleton coordinate sequences corresponding to the reference human body. The implementation of step S352 may refer to step S2 in FIG. 5.

In step S353, the computing circuit 32 obtains a candidate skeleton coordinate sequence from the plurality of reference skeleton coordinate sequences according to a start frame index and a sliding window length. Specifically, the computing circuit 32 scans the entire video 81 through the sliding window. For example, if the video 81 has N frames and the sliding window length is L frames, the candidate skeleton coordinate sequences extracted for the first time correspond to the 1^{st} frame to the L^{th} frame, the candidate skeleton coordinate sequences extracted for the second time correspond to the 2^{nd} frame to (L+1)^{th} frame, . . . , and the candidate skeleton coordinate sequences extracted for the last time correspond to the (N-L+1)^{th} frame to N^{th} frame.

In step S354, the start frame index, the sliding window length, and the candidate skeleton coordinate sequence are served as one of the first training data. In an embodiment, the first training data further includes a coach number. Specifically, different coaches have different guidance styles. Therefore, in step S351, in addition to collecting the reference video and the key frame index 83, the coach number corresponding to coach C who generates the key frame index 83 is also collected. Then, in step S354, the first training data further includes the coach number. In this way, in step S37 of FIG. 8, in addition to inputting the video 81 and the skeleton coordinate sequence, the coach number may also be inputted so that the key frame analysis model 72 may select the key frame in the video 81 according to the style of the coach C.

In an embodiment, the key frame analysis model 72 of the second embodiment not only outputs the key frame index 83, but also outputs the score of the key frame and the coach bias, the coach bias represents the tendency of the coach style to frame selection.

As shown in FIG. 5, in step S4, the pose correction model 73 generates an auxiliary image 84 according to the key frame, the key skeleton coordinate corresponding to the key frame, and the skeleton coordinate template. In an embodiment, before step S4, the server 3 has to perform the second collection procedure for a plurality of times to generate a plurality of second training data, and then train a seq2seq model as the pose correction model 73 according to the plurality of second training data. The above process may refer to step S35 and step S36 in FIG. 8, the difference lies in the second training data and the model obtained after training.

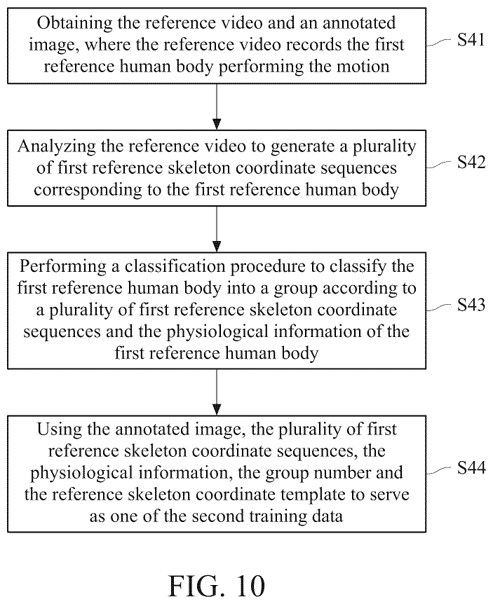

Please refer to FIG. 10. FIG. 10 is a flowchart of performing the second collection procedure once. The second collection procedure is used to collect the second training data to train the pose correction model 73. As shown in FIG. 10, performing the second collection procedure each time includes steps S41 to S44.

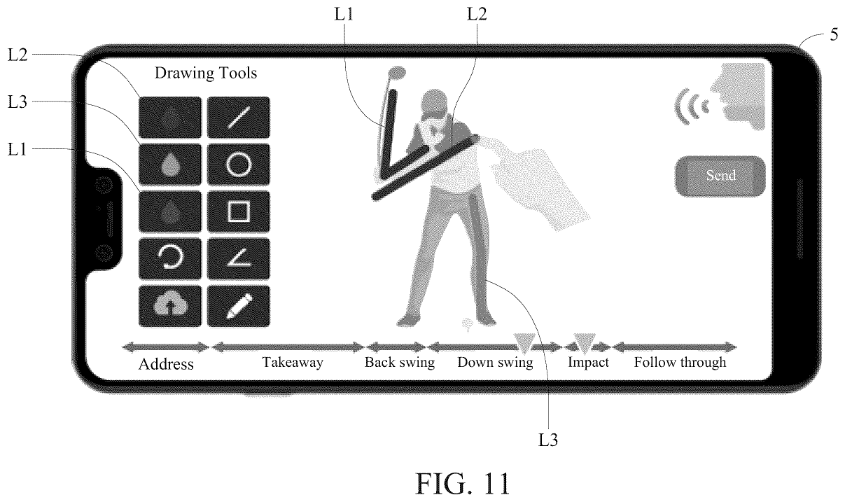

In step 41, the server 3 obtains the reference video and an annotated image. The reference video records the first reference human body performing the motion. The annotated image corresponds to the first reference human body in the reference video. Specifically, the annotated image is a part of the formal guidance generated by the coach C. FIG. 11 is a schematic diagram of the annotated image. As shown in FIG. 11, the coach C watches the video 81 of the student B through the display 54 of the electronic device 5, and then draws auxiliary lines L1, L2 and L3 to guide the correct posture of the student B. The annotated image includes the auxiliary lines L1, L2 and L3. In an embodiment, the annotated image is a three-channel image series, where the three channels correspond to RGB, and the series includes multiple coordinates that form the auxiliary line.

In step S42, the skeleton analysis module 71 analyzes the reference video to generate a plurality of first reference skeleton coordinate sequences corresponding to the first reference human body. The implementation of step S42 may refer to step S2 in FIG. 5.

In step S43, the computing circuit 32 performs a classification procedure to classify the first reference human body into a group according to a plurality of first reference skeleton coordinate sequences and the physiological information of the first reference human body. The group has a plurality of data corresponding to a plurality of second reference human bodies, each of the plurality of data includes a second reference skeleton coordinate sequence and a score. Each second reference human body is different from the first reference human body. The second reference human body corresponds to the reference video that has been classified before step S43 is executed.

In an embodiment, after the auxiliary system 100 for motion guidance has been running for a period of time, the data block 332 of the storage circuit 33 not only stores the plurality of videos 81 of different students B, but also stores the physiological information and group numbers of these students B, the skeleton coordinate sequences and the scores output by the key frame analysis model 72. The physiological information is measurable information of the human body of student B, such as height, weight, length of upper limbs or length of lower limbs, but the present disclosure is not limited to the above examples. The group number is the result of each student B being classified according to its physiological information and skeleton coordinate sequence. In other words, although the body shape of each student B is different, these students B may be classified (for example, using the K-means algorithm) according to the physiological information and skeleton coordinate sequence, so that those students B in the same group has a similar body shape.

In step S44, the annotated image, the plurality of first reference skeleton coordinate sequences, the physiological information, the group number and the reference skeleton coordinate template are served as one of the second training data. The reference skeleton coordinate template is the second reference skeleton coordinate sequence with a maximum score in the plurality of data. In an embodiment, the second training data further includes the coach number, as for more implementation details, please refer to step S354.

After the training of the pose correction model 73 is completed, the auxiliary system 100 for motion guidance may first find the group to which the new student B belongs according to his/her physiological information and skeleton coordinate sequence, and then find the best role model (reference skeleton coordinate template) in this group. Since the student B belonging to the same group have similar body shapes, by comparing the new student B with the old student who was certified by the coach C to have a standard posture, it is obviously helpful to assist the coach C to make the formal guidance.

As shown in FIG. 5, in step S5, the speech meaning analysis model 74 generates an auxiliary text 85 according to the key frame, the key skeleton coordinate corresponding to the key frame and the skeleton coordinate template, and the recommended guidance further includes the auxiliary text 85 displayed in the key frame. In an embodiment, before step S5, the server 3 has to perform the third collection procedure for a plurality of times to generate a plurality of third training data, and then train a seq2seq model as the speech meaning analysis model 74 according to the plurality of third training data. The above process may refer to step S35 and step S36 in FIG. 8, the difference lies in the third training data and the model obtained after training.

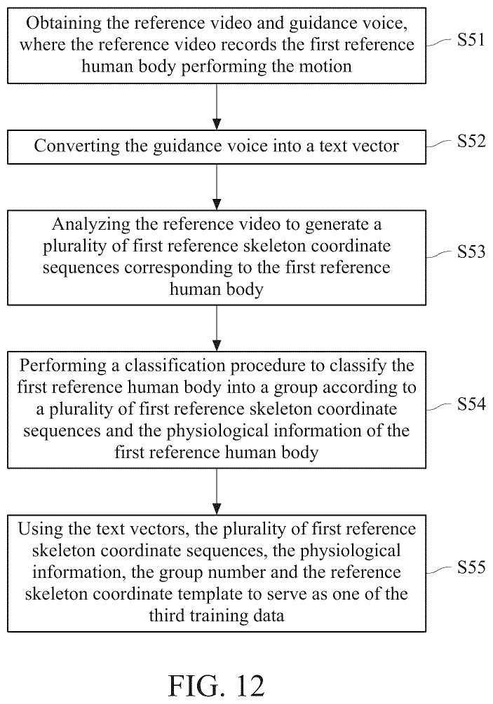

Please refer to FIG. 12. FIG. 12 is a flowchart of performing the third collection procedure once. The third collection procedure is used to collect the third training data to train the speech meaning analysis model 74. As shown in FIG. 12, performing the third collection procedure each time includes steps S51 to S54.

In step S51, the server 3 obtains the reference video and guidance voice. The reference video records the first reference human body performing the motion. The guidance voice corresponds to the first reference human body in the reference video. Specifically, similar to step S41, the guidance voice is a part of the formal guidance generated by the coach C. In step S41, the coach C guides the student B by drawing the auxiliary lines. In step S51, the coach C guides the student B by recording voice.

In step S52, the computing circuit 32 executes a conversion program to convert the guidance voice into a text vector. The conversion program adopts speech to text (STT) technology.

In step S53, the skeleton analysis module 71 analyzes the reference video to generate a plurality of first reference skeleton coordinate sequences corresponding to the first reference human body. In step S54, the computing circuit 32 performs a classification procedure to classify the first reference human body into a group according to a plurality of first reference skeleton coordinate sequences and the physiological information of the first reference human body. A group has a plurality of data corresponding to a plurality of second reference human bodies, each of the plurality of data includes a second reference skeleton coordinate sequence and a score. The implementation of steps S53 and S54 may refer to steps S42 and S43 in FIG. 10.

In step S55, the text vectors, the plurality of first reference skeleton coordinate sequences, the physiological information, the group number and the reference skeleton coordinate template are served as one of the third training data. The reference skeleton coordinate template is the second reference skeleton coordinate sequence with a maximum score in the plurality of data. In an embodiment, the third training data further includes the coach number, as for more implementation details, please refer to step S354. Step S55 is similar to step S44 in FIG. 10, the difference lies in the composition of the training data. In an embodiment, the computing circuit 32 uses natural language processing (NLP) technology to extract a representative text label from the text vector generated in step S52, and then replaces the text vector with this text label as a part of the third training data.

As shown in FIG. 5, in step S6, the server 3 sends the video 81 and the recommended guidance to the electronic device 5 of the coach C. The recommended guidance includes the composition result of the key frame and the auxiliary image 84. In another embodiment, the recommended guidance further includes the auxiliary text 85 displayed in the key frame.

In step S7, the coach C may generate the formal guidance according to the recommended guidance by the input circuit 55 of the electronic device 5. The electronic device 5 sends the formal guidance to the server 3 by the communication circuit 51. The formal guidance includes at least one of the annotated image and the guidance voice. The annotated image and the guidance voice correspond to the human body in the video 81. The server 3 then sends the formal guidance to the electronic device 1 of student B.

In an embodiment, after the server 3 receives the formal guidance, the computing circuit 32 may execute the training module 75 to adjust the hyper-parameter of at least one of the key frame analysis model 72, the pose correction model 73 and the speech meaning analysis model 74 according to the formal guidance.

In view of the above, the auxiliary system and method for motion guidance proposed by the present disclosure may achieve the following contributions and effects: in the remote teaching of sports (such as golf), the student may obtain the non-real time guidance of the coach through the present disclosure. The guidance includes auxiliary lines and guidance voice in respect to movement posture. Since the coach does not need to respond immediately, the present disclosure allows multiple students to send guidance requests to the same coach, so that an excellent coach may maximize his/her guidance efficiency. For students, when they are practicing on their own, they may obtain coach's remote guidance through the present disclosure, and may clearly see their motion videos with audio-visual guidance suggestions. For the coach, the present disclosure proposes a remote teaching method across geographical restrictions. The proposed method is not limited to one-to-one teaching at a single time, thereby greatly improving the teaching efficiency of the coach.

What is claimed is:

1. An auxiliary method of motion guidance performed by a server and comprising:
obtaining a video recording a human body performing a motion;
analyzing, by a skeleton analysis module, the video to generate a plurality of skeleton coordinate sequences corresponding to the human body;
specifying, by a key frame analysis model, a key frame at least according to the video and the plurality of skeleton coordinate sequences;
generating, by a pose correction model, an auxiliary image according to the key frame, a key skeleton coordinate corresponding to the key frame, and a skeleton coordinate template; and
sending, by the server, the video and a recommended guidance to an electronic device, wherein the recommended guidance comprises a composite result of the key frame and auxiliary image.

2. The auxiliary method of motion guidance of claim 1, further comprising:
generating, by a speech meaning analysis model running on the server, an auxiliary text according to the key frame, the key skeleton coordinate corresponding to the key frame and the skeleton coordinate template, wherein the recommended guidance further comprises the auxiliary text displayed in the key frame.

3. The auxiliary method of motion guidance of claim 1, wherein the motion comprises a plurality of stages, and specifying, by the key frame analysis model, the key frame at least according to the video and the plurality of skeleton coordinate sequences comprises:
calculating a plurality of first scores of the plurality of stages according to the plurality of skeleton coordinate sequences and a basic rule set;
finding a first minimum in the plurality of first scores;
calculating a plurality of second scores of a plurality of frames of a candidate stage according to the plurality of skeleton coordinate sequences and an advanced rule set, wherein the candidate stage is one of the plurality of stages and corresponds to the first minimum; and
finding a second minimum in the plurality of second scores and outputting one of the plurality of frames corresponding to the second minimum as the key frame.

4. The auxiliary method of motion guidance of claim 1, further comprising:
performing, by the server, a collection procedure for a plurality of times to generate a plurality of training data; and
training, by the server, a sequence-to-sequence model as the key frame analysis model according to the plurality of training data;
wherein each of the plurality of times performing the collection procedure comprises:
obtaining a reference video and a key frame index corresponding the reference video, wherein the reference video records a reference human body performing the motion;
analyzing, by the skeleton analysis module, the reference video to generate a plurality of reference skeleton coordinate sequences corresponding to the reference human body;
obtaining a candidate skeleton coordinate sequence from the plurality of reference skeleton coordinate sequences according to a start frame index and a sliding window length; and
using the start frame index, the sliding window length, and the candidate skeleton coordinate sequence to serve as one of the plurality of training data.

5. The auxiliary method of motion guidance of claim 1, further comprising:
performing, by the server, a collection procedure for a plurality of times to generate a plurality of training data; and
training, by the server, a sequence-to-sequence model as the pose correction model according to the plurality of training data;
wherein each of the plurality of times performing the collection procedure comprises:
obtaining a reference video and an annotated image, wherein the reference video records a first reference human body performing the motion, the annotated image corresponds to the first reference human body in the reference video;
analyzing, by the skeleton analysis module, the reference video to generate a plurality of first reference skeleton coordinate sequences corresponding to the first reference human body;
performing a classification procedure to classify the first reference human body into a group according to the plurality of first reference skeleton coordinate sequences and physiological information of the first reference human body, wherein the group has a plurality of data corresponding to a plurality of second reference human bodies, each of the plurality of data comprises a second reference skeleton coordinate sequence and a score; and
using the annotated image, the plurality of first reference skeleton coordinate sequences, the physiological information, a group number and a reference skeleton coordinate template to serve as one of the plurality of training data, wherein the reference skeleton coordinate template is the second reference skeleton coordinate sequence with a maximal value of the score in the plurality of data.

6. The auxiliary method of motion guidance of claim 2, further comprising:
performing, by the server, a collection procedure for a plurality of times to generate a plurality of training data; and
training, by the server, a sequence-to-sequence model as the speech meaning analysis model according to the plurality of training data;
wherein each of the plurality of times performing the collection procedure comprises:
obtaining a reference video and guidance voice, wherein the reference video records a first reference human body performing the motion, the guidance voice corresponds to the first reference human body in the reference video;
converting the guidance voice into a text vector by a conversion program;
analyzing, by the skeleton analysis module, the reference video to generate a plurality of first reference skeleton coordinate sequences corresponding to the first reference human body;
performing a classification procedure to classify the first reference human body into a group according to the plurality of first reference skeleton coordinate sequences and physiological information of the first reference human body, wherein the group has a plurality of data corresponding to a plurality of second reference human bodies, each of the plurality of data comprises a second reference skeleton coordinate sequence and a score; and
using the text vector, the plurality of first reference skeleton coordinate sequences, the physiological information, a group number and a reference skeleton coordinate template to serve as one of the plurality of training data, wherein the reference skeleton coordinate template is the second reference skeleton coordinate sequence with a maximal value of the score in the plurality of data.

7. The auxiliary method of motion guidance of claim 2, further comprising:
generating, by an input circuit of the electronic device, a formal guidance according to the recommended guidance;
sending, by a communication circuit of the electronic device, the formal guidance to the server, wherein the formal guidance comprises at least one of an annotated image and a guidance voice, and the annotated image and the guidance voice correspond to the human body in the video; and
performing a training module by the server, wherein the training module is used to adjust a hyper-parameter of at least one of the key frame analysis model and the pose correction model according to the formal guidance.

8. An auxiliary system of motion guidance comprising:
a server comprising:
a communication circuit configured to receive a video, send the video and send a recommended guidance, wherein the video records a human body performing a motion;
a computing circuit electrically connecting to the communication circuit, wherein the computing circuit is configured to:
perform a skeleton analysis module to analyze the video to generate a plurality of skeleton coordinate sequences corresponding to the human body;
perform a key frame analysis model to specify a key frame at least according to the video and the plurality of skeleton coordinate sequences; and
perform a pose correction model to generate an auxiliary image according to the key frame, a key skeleton coordinate corresponding to the key frame, and a skeleton coordinate template;
a storage circuit electrically connecting to the computing circuit, wherein the storage circuit is configured to store the skeleton analysis module, the plurality of skeleton coordinate sequences, the key frame analysis model, an index of the key frame, the pose correction model, and the auxiliary image; and
an electronic device communicably connecting to the server, wherein the electronic device is configured to receive the video and the recommended guidance, and the recommended guidance comprises a composite result of the key frame and the auxiliary image.

9. The auxiliary system of motion guidance of claim 8, wherein
the computing circuit is further configured to perform a speech meaning analysis model to generate an auxiliary text according to the key frame, the key skeleton coordinate corresponding to the key frame and the skeleton coordinate template, wherein the recommended guidance further comprises the auxiliary text displayed in the key frame; and
the storage circuit is further configured to store the speech meaning analysis model and the auxiliary text.

10. The auxiliary system of motion guidance of claim 8, wherein the motion comprises a plurality of stages, and performing the key frame analysis model by the computing circuit to specify the key frame at least according to the video and the plurality of skeleton coordinate sequences comprises:
calculating a plurality of first scores of the plurality of stages according to the plurality of skeleton coordinate sequences and a basic rule set;
finding a first minimum in the plurality of first scores;
calculating a plurality of second scores of a plurality of frames of a candidate stage according to the plurality of skeleton coordinate sequences and an advanced rule set, wherein the candidate stage is one of the plurality of stages and corresponds to the first minimum; and
finding a second minimum in the plurality of second scores and outputting one of the plurality of frames corresponding to the second minimum as the key frame.

11. The auxiliary system of motion guidance of claim 8, wherein the computing circuit is further configured to:
perform a collection procedure for a plurality of times to generate a plurality of training data; and
train a sequence-to-sequence model as the key frame analysis model according to the plurality of training data;
wherein each of the plurality of times performing the collection procedure comprises:
obtaining a reference video and a key frame index corresponding the reference video, wherein the reference video records a reference human body performing the motion;
analyzing, by the skeleton analysis module, the reference video to generate a plurality of reference skeleton coordinate sequences corresponding to the reference human body;
obtaining a candidate skeleton coordinate sequence from the plurality of reference skeleton coordinate sequences according to a start frame index and a sliding window length; and
using the start frame index, the sliding window length, and the candidate skeleton coordinate sequence to serve as one of the plurality of training data.

12. The auxiliary system of motion guidance of claim 8, wherein the computing circuit is further configured to:
perform a collection procedure for a plurality of times to generate a plurality of training data; and
train a sequence-to-sequence model as the pose correction model according to the plurality of training data;
wherein each of the plurality of times performing the collection procedure comprises:
obtaining a reference video and an annotated image, wherein the reference video records a first reference human body performing the motion, the annotated image corresponds to the first reference human body in the reference video;
analyzing, by the skeleton analysis module, the reference video to generate a plurality of first reference skeleton coordinate sequences corresponding to the first reference human body;
performing a classification procedure to classify the first reference human body into a group according to the plurality of first reference skeleton coordinate sequences and physiological information of the first reference human body, wherein the group has a plurality of data corresponding to a plurality of second reference human bodies, each of the plurality of data comprises a second reference skeleton coordinate sequence and a score; and
using the annotated image, the plurality of first reference skeleton coordinate sequences, the physiological information, a group number and a reference skeleton coordinate template to serve as one of the plurality of training data, wherein the reference skeleton coordinate template is the second reference skeleton coordinate sequence with a maximal value of the score in the plurality of data.

13. The auxiliary system of motion guidance of claim 9, wherein the computing circuit is further configured to:
perform a collection procedure for a plurality of times to generate a plurality of training data; and
train a sequence-to-sequence model as the speech meaning analysis model according to the plurality of training data;
wherein each of the plurality of times performing the collection procedure comprises:
obtaining a reference video and guidance voice, wherein the reference video records a first reference human body performing the motion, the guidance voice corresponds to the first reference human body in the reference video;
converting the guidance voice into a text vector by a conversion program;
analyzing, by the skeleton analysis module, the reference video to generate a plurality of first reference skeleton coordinate sequences corresponding to the first reference human body;
performing a classification procedure to classify the first reference human body into a group according to the plurality of first reference skeleton coordinate sequences and physiological information of the first reference human body, wherein the group has a plurality of data corresponding to a plurality of second reference human bodies, each of the plurality of data comprises a second reference skeleton coordinate sequence and a score; and
using the text vector, the plurality of first reference skeleton coordinate sequences, the physiological information, a group number and a reference skeleton coordinate template to serve as one of the plurality of training data, wherein the reference skeleton coordinate template is the second reference skeleton coordinate sequence with a maximal value of the score in the plurality of data.

14. The auxiliary system of motion guidance of claim 9, wherein the electronic device further comprises:
an input circuit configured to generate a formal guidance according to the recommended guidance; and
a communication circuit electrically connecting to the input circuit, wherein the communication circuit is configured to send the formal guidance to the server, the formal guidance comprises at least one of an annotated image and a guidance voice, and the annotated image and the guidance voice correspond to the human body in the video;
wherein the computing circuit of the server is further configured to perform a training module, the training module is used to adjust a hyper-parameter of at least one of the key frame analysis model and the pose correction model according to the formal guidance, and the storage circuit of the server is further configured to store the training module.
